(19) United States
(12) Patent Application Publication
(10) Pub. No.: US 2003/0072841 A1
(43) Pub. Date: Apr. 17, 2003

(54) Polybutene containing chewing gum and confection

(75) Inventors: Jayanth Rajaiah, Loveland, OH (US); Lisa Catron Ernst, Cincinnati, OH (US); Ann Maria Case, Cincinnati, OH (US); Thinh Nguyen Ha, Cincinnati, OH (US); William Michael Glandorf, Mason, OH (US); Christopher Robert Mayer, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Campany

(21) Appl. No.: 10/084,897

(22) Filed: Feb. 28, 2002

Related U.S. Application Data
(60) Provisional application No. 60/276,975, filed on Mar. 19, 2001.
(60) Provisional application No. 60/276,978, filed on Mar. 19, 2001.

(51) Int. Cl. A23G 3/30

(52) U.S. Cl. 426/3

(57) ABSTRACT

Chewing gum and confection compositions that inhibit the buildup of plaque and other debris on teeth, comprising polybutene with a molecular weight of 300 to about 3000. Upon its release from the gum or confection piece by chewing or dissolving the polybutene forms a protective coating on the hard tissue surfaces of the oral cavity and may, optionally, provide sustained release of a cosmetic and/or therapeutic active ingredient to deliver prolonged therapeutic, prophylactic and/or cosmetic benefits.

### CROSS-REFERENCE TO RELATED APPLICATIONS

This application claims the benefit of U.S. Provisional Application No. 60/276,975, filed Mar. 19, 2001 and U.S. Provisional Application No. 60/276,978 also filed Mar. 19, 2001.

### FIELD OF THE INVENTION

The present invention relates to chewing gum and confection compositions that comprise low molecular weight polybutene and, optionally, cosmetic and/or therapeutic actives.

### BACKGROUND OF THE INVENTION

Oral and denture care compositions by which various cosmetic and/or therapeutic actives can be delivered to the hard surface of the teeth are also known. Examples of such dental products include: brushing aids such as dentifrice products for delivery of anti-caries actives like fluoride; mouthwashes containing breath fresheners or antibacterial actives; and effervescent denture cleansing tablets which require the artificial teeth to soak for a period of time to remove plaque and debris that has built up on the denture or other artificial dental prosthesis. It is known that such dental products can provide both cosmetic and/or therapeutic benefits to consumers.

Chewing gum and confection compositions that deliver cosmetic and/or therapeutic benefits to the oral cavity are also known in the art. Typical examples include: chewing gums or confections that deliver breath freshening ingredients, flavorants or coolants in order to eliminate malodourous breath; and analgesic containing gums and confections that provide the consumer with relief from sore throat pain.

However, known chewing gum and confection compositions containing cosmetic and/or therapeutic actives often do not successfully maintain those actives in the oral cavity long enough to optimally enhance or prolong the therapeutic, prophylactic and/or cosmetic benefits provided.

Polybutene is recognized as a component of denture adhesives and as a gum base. U.S. Pat. No. 5,880,172, issued Mar. 3, 1999, to Rajaiah, et al., discloses a self-supporting denture adhesive that is peelable for easy removal, which incorporates polybutene as an optional ingredient. U.S. Pat. No. 5,496,541, issued Mar. 5, 1996, to Cutler, relates to a dentifrice chewing gum and teaches the use of polybutene as an optional gum base. Such known applications often employ higher molecular weight polybutene in order to achieve the desired result.

In the present invention lower molecular weight polybutene is incorporated into chewing gum and confection compositions to provide a protective coating on the teeth. The chewing gums and confections of the present invention will release the lower molecular weight polybutene upon chewing or dissolution, thereby coating the teeth. Optionally the compositions of the present invention will provide sustained release of cosmetic and/or therapeutic actives. The lower molecular weight polybutene in a chewing gum or confection provides a coating on the teeth and hard surfaces of the oral cavity with sufficient substantivity to provide sustained release of the active. The polybutene component of the chewing gum or confection thereby protects the hard surfaces from the buildup of plaque, bacteria and other debris, thereby inhibiting or preventing gingivitis, caries and staining. This coating also provides a slick, smooth feel to the hard surfaces of the oral cavity which consumers view as an indicator of clean teeth.

### SUMMARY OF THE INVENTION

This invention relates to chewing gum and confection compositions that inhibit the buildup of plaque and other debris on teeth. The compositions comprise polybutene with a molecular weight of about 300 to about 3000. The compositions may also comprise one or more flavorants, sweeteners and cosmetic and/or therapeutic actives. The optional active is selected from the group consisting of anti-calculus (anti-tartar agents), fluoride ion sources, stannous ion sources, whitening agents, anti-microbial and anti-plaque agents, anti-inflammatory agents, nutrients, antioxidants, anti-viral agents, anti-fungal agents, analgesic and anesthetic agents, H-2 antagonists, fragrances and sensates, pigments and colorants, components other than polybutene which impart a clean feel to the teeth, and mixtures thereof. Where appropriate, a viscosity modifier may optionally be incorporated in compositions of the present invention. Upon chewing or dissolving of the gum or confection piece, the polybutene forms a coating on the hard surfaces of the oral cavity. Optionally, by incorporating a therapeutic or cosmetic active in the compositions, sustained release of the active, from the aforementioned hard surface coating, may deliver prolonged therapeutic, prophylactic and/or cosmetic benefits to the oral cavity.

The compositions of the present invention are comprised of two components, a polybutene component and a chewing gum or confection component. The polybutene component is comprised of lower molecular weight polybutene and, optionally, one or more cosmetic and/or therapeutic actives, natural or artificial sweeteners or flavorants.

In one embodiment the polybutene component is evenly distributed throughout the chewing gum or confection component. In another embodiment the chewing gum or confection composition is a filled composition comprising the polybutene component, as described above, encapsulated within a chewing gum or confection outer shell.

### DETAILED DESCRIPTION OF THE INVENTION

Definitions

The term “teeth” or “hard surfaces of the oral cavity”, as used herein, is meant to include natural teeth, artificial teeth, dentures, dental plates, bridges, dental implants and any other hard dental prosthesis pennanently or temporarily fixed within the oral cavity.

“Tartar” and “calculus” are used interchangeably and refer to mineralized dental =plaque biofilms.

The term “carrier materials” as used herein means any safe and effective chewing gum or confection components known in the art. Such materials include gum bases, resins and plasticizers, elastomer solvents, waxes, abrasive polishing materials, fats, emulsifiers, softeners, bulking agents, sweeteners, flavorants, water, humectants, viscosity modifiers, thickeners, xylitol, alkali metal bicarbonate salts, buffering agents, surfactants, opacifiers such as titanium dioxide, chelants such as ethylenediaminetetraacetic acid, and mixtures thereof.

The term “unit dose form” refers to physically discrete units suitable as unitary dosages for human subjects and other mammals, each containing a predetermined quantity of active material calculated to produce the desired therapeutic or cosmetic effect.

By “safe and effective amount”, as used herein, is meant an amount of an active agent (e.g., anti-calculus agent) high enough to significantly improve the condition to be treated, but low enough to avoid serious side effects (at a reasonable benefit/risk ratio), within the scope of sound medical/dental judgment. The safe and effective amount of an agent (e.g., anti-calculus agent) may vary with the particular condition being treated, the age and physical condition of the patient being treated, the severity of the condition, the duration of treatment, the nature of concurrent therapy, the specific form of the source employed, and the particular vehicle from which the agent is applied.

The term “mucoadhesive” or “bioadhesive” as used herein refers to the phenomenon where a natural or synthetic substance applied to a wet mucosal epithelium adheres, usually creating a new interface, to the mucous layer. (CRC Critical Review in Ther. Drug Carrier, Vol.5, Issue 1, p.21 (1988)). Generally, mucoadhesion can be achieved via physical or chemical processes, or both. This mechanism is described in Journal of Controlled Release, Vol.2, p257 (1982) and Journal of Controlled Release, Vol.18 (1992) p. 249. The above references are incorporated by reference herein in their entirety.

The term “viscosity” as used herein refers to kinematic viscosity, measured using the standard test method for Kinematic Viscosity of Transparent and Opaque Liquids (the Calculation of Dynamic Viscosity),, ASTM D-445. As reported, viscosity is measured at 99° C. (210° F.) unless otherwise indicated. A sample is placed in a U-shaped, Ostwald type, “Cannon-Fenske”, viscometer (for transparent liquids) tube and submerged into a constant temperature bath. Flow is timed between two marks on the tube and viscosity is determined by simple calculations dependent on time and a standard factor supplied by the tube manufacturer.

“Molecular weight”, as referred to herein, is reported as a number average, determined using gel permeation chromatography. The number average molecular weight, or arithmetic mean, is a function of the number of molecules in a given mass of polymer. It is represented by the formula:

$${M}_{n} = \frac{Σ {N}_{i} {M}_{i}}{Σ {N}_{i}} = \frac{Σ {n}_{i} {M}_{i}}{}$$

where Nᵢ, represents the number of molecules present for a given molecular weight, Mᵢ and nᵢ=Nᵢ/ΣNᵢ is the number fraction of molecular weight, Mᵢ.

Percentages and ratios herein are by weight of total composition, unless otherwise indicated.

Polybutene

Polybutene is a viscous copolymer of isobutylene and butene monomers. “Polybutene”, as used herein, refers to both hydrogenated (CAS #68937-10-0) and unhydrogenated (CAS #9003-29-6) forms of the polymer. Polybutene is a viscous, colorless, non-drying, liquid polymer. Polybutenes may range from a very flowable liquid to a near semi-solid state. Polybutenes are clear, odorless, chemically stable, resistant to oxidation by light and heat, non-toxic and non-hazardous.

The compositions of the present invention comprise polybutene of a lower molecular weight, from about 300 to about 3000, in another embodiment from about 500 to about 2200, and in yet another embodiment from about 750 to about 1500. The viscosity of the polybutene disclosed herein, ranges from about 30cSt (centi Stoke) measured at 38° C. to about 4,500cSt measured at 99° C., in another embodiment from about 20OcSt measured at 38° C. to about 3,500 cSt measured at 99° C. and in another embodiment 75 cSt measured at 99° C. to about 700 cSt measured at 99° C. Polybutene is included from about 0.01% to about 99.9%, in another embodiment from about 1% to about 99%, and in yet another embodiment from about 50% to about 90%, by weight of the composition.

The lower molecular weight polybutene (molecular weight from about 300 to about 3000) of the present invention does not exhibit elastomeric properties. Elastomers are amorphous polymers that have the ability to stretch out and spring back to their original shapes. Such elastomeric polymers must have a modest amount of cross-linking to prevent the polymeric chains from slipping over one another, and the chains must have an irregular shape to prevent the formation of crystalline regions within the polymeric chains. Synthetic elastomers are described in more detail in Kirk-Othmer, Encyclopedia of Chemical Technology, Fourth Edition, Volume 8, Wiley-Interscience Publishers (1996), pages 934-955. In contrast, the polybutene of the present invention is not cross-linked and does not exhibit rubbery or elastic behavior. When subjected to a stretching or bending force, the polybutene useful for the present invention does not regain its original shape upon the removal of the force.

Lower molecular weight polybutene (Molecular Weight=300-3000), which is a flowable liquid known for its adhesive properties, is actually non-mucoadhesive. That is, the polybutene, while displaying excellent adhesion properties on the hard surfaces of the oral cavity, will not significantly adhere to the mucosa or wet, soft tissue of the mouth. In fact, polybutene is extremely substantive when applied to the teeth, making it suitable for once daily application and treatment of the teeth. High retention of the polybutene is achieved, even when thorough brushing of the teeth has occurred. Thus, the polybutene, once applied to the tooth surface, is long lasting and rinse resistant, which allows for sustained release of the optional cosmetic and/or therapeutic actives. Once applied to the teeth, polybutene has a very smooth, slick texture, perceived by the consumer as a desirable, clean feeling. The polybutene acts as a lubricant on the teeth, reducing the friction normally generated when the tongue slides over the teeth.

Suitable polybutenes for use herein include, but are not limited to: Indopol L-14, Molecular Weight (“MW”)=370; Indopol L-50, MW=455; Indopol L-65, MW=435; Indopol L-100, MW=510, H-15, MW=600; H-25, MW=670; H-35, MW=725; H-40, MW=750; H-50, MW=815; H-100, MW=940; H-300, MW=1330; H-1500, MW=2145; H-1900, MW=2270; Panalane L-14E, MW=370; Panalane H-300E, MW=1330; all trade names of BP Amoco Chemicals (Chicago, Ill.). Other suitable grades of polybutene include Parapol 450, MW=420; Parapol 700, MW=700; Parapol 950, MW=950; Parapol 1300, MW=1300; and Parapol 2500, MW==2700; all trade names of ExxonMobil Corporation.

Cosmetic and/or Therapeutic Actives

The compositions of the present invention comprise polybutene with a molecular weight from about 300 to about 3000. The polybutene component may be dispersed throughout the gum or confection or, alternatively, may be used as a fill composition encapsulated within a gum or confection outer shell. In addition, the compositions of the present invention may optionally contain one or more cosmetic and/or therapeutic actives in unit dose form where, upon directed use, the benefit sought by the wearer is promoted without detriment to the oral surface to which it is applied. Examples of the oral conditions these actives address include, but are not limited to, appearance and structural changes to teeth, and treatment and prevention of plaque, tartar, cavities, inflamed and/or bleeding gums, gingivitis, fungal infections such as candida, mucosal wounds, lesions, ulcers, aphthous ulcers, cold sores, tooth abscesses, and the elimination of mouth malodor resulting from the conditions above and other causes such as microbial proliferation.

Suitable cosmetic and/or therapeutic actives include any material that is generally considered safe for use in the oral cavity and that provides changes to the overall appearance and/or health of the oral cavity, including without limitation, anti-calculus agents, fluoride ion sources, stannous ion sources, whitening agents, anti-microbial, anti-plaque agents, anti-inflammatory agents, nutrients, antioxidants, anti-viral agents, anti-fungal agents, analgesic and anesthetic agents, H-2 antagonists, components other than polybutene which impart a clean feel to the teeth, pigments and colorants, fragrances and sensates, and mixtures thereof. When present, the level of cosmetic and/or therapeutic active in the compositions utilized by the present invention is generally, unless otherwise noted, from about 0.001% to about 90%, in one embodiment from about 0.01% to about 50%, in another embodiment from about 0.1% to about 30%, by weight of the composition. Where the cosmetic and/or therapeutic actives are in particulate form, a suitable particle size for use in the present invention is from about 0.001 to about 1000 microns, in one embodiment from about 0.1 to 500 microns, in another embodiment from about 1 to about 1 00 microns.

Chewing gum or confection compositions of the present invention may include many of the cosmetic and/or therapeutic actives previously disclosed in the art. The actives may be added to one or more of the polybutene, gum or confection components. Where the compositions of the present invention are filled or coated, one or more cosmetic and/or therapeutic actives may be added to the fill composition and/or the shell composition. Where both immediate release and sustained release of one or more cosmetic and/or therapeutic actives are desired, or where the actives are otherwise incompatible, those actives may be separately added to one or more of the polybutene, gum or confection component of the coating layer or layers. The following is a non-limiting list of actives that may be used in the present invention.

The present invention may comprise an anti-calculus agent, which may present from about 0.001% to about 50%, by weight of the polybutene component, in another embodiment is from about 0.01% to about 25%, and in yet another embodiment is from about 0.1% to about 15%. The anti-calculus agent may be selected from the group consisting of polyphosphates (including pyrophosphates) and salts thereof; polyamino propane sulfonic acid (AMPS) and salts thereof; polyolefin sulfonates and salts thereof; polyvinyl phosphates and salts thereof; polyolefin phosphates and salts thereof; diphosphonates and salts thereof; phosphonoalkane carboxylic acid and salts thereof; polyphosphonates and salts thereof; polyvinyl phosphonates and salts thereof; polyolefin phosphonates and salts thereof; polypeptides; and mixtures thereof. In one embodiment, the salts are alkali metal salts. Polyphosphates are generally employed as their wholly or partially neutralized water-soluble alkali metal salts such as potassium, sodium, ammonium salts, and mixtures thereof. The inorganic polyphosphate salts include alkali metal (e.g. sodium) tripolyphosphate, tetrapolyphosphate, dialkyl metal (e.g. disodium) diacid, trialkyl metal (e.g. trisodium) monoacid, potassium hydrogen phosphate, sodium hydrogen phosphate, and alkali metal (e.g. sodium) hexametaphosphate, and mixtures thereof. Polyphosphates larger than tetrapolyphosphate usually occur as amorphous glassy materials. In one embodiment the polyphosphates are those manufactured by FMC Corporation, which are commercially known as Sodaphos (n≈6), Hexaphos (n≈13), and Glass H (n≈21, sodium hexametaphosphate), and mixtures thereof. The pyrophosphate salts useful in the present invention include, alkali metal pyrophosphates, di-, tri-, and mono-potassium or sodium pyrophosphates, dialkali metal pyrophosphate salts, tetraalkali metal pyrophosphate salts, and mixtures thereof. In one embodiment the pyrophosphate salt is selected from the group consisting of trisodium pyrophosphate, disodium dihydrogen pyrophosphate (Na₂H₂P₂O₇), dipotassium pyrophosphate, tetrasodium pyrophosphate (Na₄P₂O₇), tetrapotassium pyrophosphate (K₄P₂O₇), and mixtures thereof. Polyolefin sulfonates include those wherein the olefin group contains 2 or more carbon atoms, and salts thereof. Polyolefin phosphonates include those wherein the olefin group contains 2 or more carbon atoms. Polyvinylphosphonates include polyvinylphosphonic acid. Diphosphonates and salts thereof include azocycloalkane-2,2-diphosphonic acids and salts thereof, ions of azocycloalkane-2,2-diphosphonic acids and salts thereof, azacyclohexane-2,2-diphosphonic acid, azacyclopentane-2,2-diphosphonic acid, N-methyl-azacyclopentane-2,3-diphosphonic acid, EHDP (ethane-1-hydroxy-1,1,-diphosphonic acid), AHP (azacycloheptane-2,2-diphosphonic acid), ethane-1-amino-1,1-diphosphonate, dichloromethane-diphosphonate, etc. Phosphonoalkane carboxylic acid or their alkali metal salts include PPTA (phosphonopropane tricarboxylic acid), PBTA (phosphonobutane-1,2,4-tricarboxylic acid), each as acid or alkali metal salts. Polyolefin phosphates include those wherein the olefin group contains 2 or more carbon atoms. Polypeptides include polyaspartic and polyglutamic acids.

Fluoride ion sources are well known for use in oral care compositions as anti-caries agents and may optionally be incorporated within the present invention. Application of fluoride ions to the dental enamel of natural teeth serves to protect those teeth against decay. A wide variety of fluoride ion-yielding materials can be employed as sources of soluble fluoride in the instant compositions. Examples of suitable fluoride ion-yielding materials are found in Briner, et al., U.S. Pat. No. 3,535,421 and Widder, et al., U.S. Pat. No. 3,678,154. Preferred fluoride ion sources for use herein include sodium fluoride, potassium fluoride, stannous fluoride, mono fluoro phosphate (MFP), and ammonium fluoride. In one embodiment sodium fluoride is the fluoride ion source. The instant invention provides from about 5 ppm to about 10,000 ppm, in one embodiment from about 100 to 3000 ppm, of fluoride ions in the total chewing gum or confection composition.

The chewing gum and confection compositions of the present invention may include a stannous ion source. The stannous ions may be provided from stannous fluoride and/or other stannous salts. Stannous fluoride has been found to help in the reduction of gingivitis, plaque, sensitivity, and in improved breath benefits. The stannous ions provided in an oral composition will provide efficacy to a subject using the composition. Although efficacy could include benefits other than the reduction in gingivitis, efficacy is defined as a noticeable amount of reduction in in situ plaque metabolism. Formulations providing such efficacy typically include stannous levels provided by stannous fluoride and/or other stannous salts ranging from about 3,000 ppm to about 15,000 ppm stannous ions in the total composition. Below about 3,000 ppm stannous the efficacy of the stannous is not sufficient. The stannous ion is present in an amount of from about 4,000 ppm to about 12,000 ppm, in one embodiment from about 5,000 ppm to about 10,000 ppm. Other stannous salts include organic stannous carboxylates, such as stannous acetate, stannous gluconate, stannous oxalate, stannous malonate, stannous citrate, stannous ethylene glycoxide, stannous formate, stannous sulfate, stannous lactate, stannous tartrate, and the like. Other stannous ion sources include, stannous halides such as stannous chlorides, stannous bromide, stannous iodide and stannous chloride dihydride. In one embodiment the stannous ion source is stannous fluoride in another embodiment, stannous chloride dihydrate. The combined stannous salts may be present in an amount of from about 0.001% to about 11%, by weight of the compositions. The stannous salts may typically be present in an amount of from about 0.01% to about 7%, in one embodiment from about 0.1% to about 5%, and in yet another embodiment from about 1.5% to about 3%, by weight of the composition.

Anti-microbial agents may be included in the compositions of the present 25 invention. Such agents may include, but are not limited to: 5-chloro-2-(2,4-dichlorophenoxy)-phenol, commonly referred to as triclosan; 8-hydroxyquinoline and its salts; copper II compounds, including, but not limited to, copper(II) chloride, copper(II) sulfate, copper(II) acetate, copper(II) fluoride and copper(II) hydroxide; phthalic acid and its salts including, but not limited to those disclosed in U.S. Pat. 4,994,262, preferably magnesium monopotassium phthalate; chlorhexidine; alexidine; hexetidine; sanguinarine; benzalkonium chloride; salicylanilide; domiphen bromide; cetylpyridinium chloride (CPC); tetradecylpyridinium chloride (TPC); N-tetradecyl-4-ethylpyridinium chloride (TDEPC); octenidine; iodine; sulfonamides; bisbiguanides; phenolics; delmopinol, octapinol, and other piperidino derivatives; niacin preparations; zinc or stannous ion agents; nystatin; grapefruit extract; apple extract; thyme oil; thymol; antibiotics such as augmentin, amoxicillin, tetracycline, doxycycline, minocycline, metronidazole, neomycin, kanamycin, cetylpyridinium chloride, and clindamycin; analogs and salts of the above; essential oils including thymol, geraniol, carvacrol, citral, hinokitiol, eucalyptol, catechol (particularly 4-allyl catechol) and mixtures thereof; methyl salicylate; hydrogen peroxide; metal salts of chlorite; and mixtures of all of the above. Anti-microbial components may be present from about 0.001% to about 20% by weight of the composition.

The compositions of the present invention may include an anti-plaque agent such as stannous salts, copper salts, strontium salts, magnesium salts or a dimethicone copolyol. The dimethicone copolyol is selected from C12 to C20 alkyl dimethicone copolyols and mixtures thereof. In one embodiment the dimethicone copolyol is cetyl dimethicone copolyol marketed under the Trade Name Abil EM90. The dimethicone copolyol is generally present in a level of from about 0.001% to about 25%, in one embodiment from about 0.01% to about 5% and in another embodiment from about 0.1% to about 1.5% by weight of the composition.

Anti-inflammatory agents can also be present in the chewing gum and confection compositions of the present invention. Such agents may include, but are not limited to, non-steroidal anti-inflammatory agents oxicams, salicylates, propionic acids, acetic acids and fenamates. Such NSAIDs include but are not limited to ketorolac, flurbiprofen, ibuprofen, naproxen, indomethacin, diclofenac, etodolac, indomethacin, sulindac, tolmetin, ketoprofen, fenoprofen, piroxicam, nabumetone, aspirin, diflunisal, meclofenamate, mefenamic acid, oxyphenbutazone, phenylbutazone and acetaminophen. Use of NSAIDs such as ketorolac are claimed in U.S. Pat. No. 5,626,838, issued May 6, 1997. Disclosed therein are methods of preventing and/or treating primary and reoccurring squamous cell carcinoma of the oral cavity or oropharynx by topical administration to the oral cavity or oropharynx of an effective amount of an NSAID. Suitable steroidal anti-inflammatory agents include corticosteroids, such as fluccinolone, and hydrocortisone.

Nutrients may improve the condition of the oral cavity and can be included in the chewing gum and confection compositions of the present invention. Nutrients include minerals, vitamins, oral nutritional supplements, enteral nutritional supplements, and mixtures thereof. Useful minerals include calcium, phosphorus, zinc, manganese, potassium and mixtures thereof. Vitamins can be included with minerals or used independently. Suitable vitamins include Vitamins C and D, thiamine, riboflavin, calcium pantothenate, niacin, folic acid, nicotinamide, pyridoxine, cyanocobalamin, para-aminobenzoic acid, bioflavonoids, and mixtures thereof. Oral nutritional supplements include amino acids, lipotropics, fish oil, and mixtures thereof. Amino acids include, but are not limited to L-Tryptophan, L-Lysine, Methionine, Threonine, Levocarnitine or L-carnitine and mixtures thereof. Lipotropics include, but are not limited to, choline, inositol, betaine, linoleic acid, linolenic acid, and mixtures thereof. Fish oil contains large amounts of Omega-3 (N-3) polyunsaturated fatty acids, eicosapentaenoic acid and docosahexaenoic acid. Enteral nutritional supplements include, but are not limited to, protein products, lo glucose polymers, corn oil, safflower oil, medium chain triglycerides. Minerals, vitamins, oral nutritional supplements and enteral nutritional supplements are described in more detail in Drug Facts and Comparisons (loose leaf drug information service), Wolters Kluer Company, St. Louis, Mo., ©1997, pps. 3-17 and 54-57.

A whitening agent may be included as an active in the present compositions. The actives suitable for whitening are selected from the group consisting of alkali metal and alkaline earth metal peroxides, metal chlorites, perborates inclusive of mono and tetrahydrates, perphoshates, percarbonates, peroxyacids, alkali metal and persulfates, such as ammonium, potassium, sodium and lithium persulfates, and combinations thereof. Suitable peroxide compounds include hydrogen peroxide, urea peroxide, calcium peroxide, carbamide peroxide, magnesium peroxide, zinc peroxide, strontium peroxide and mixtures thereof. In one embodiment the peroxide compound is carbamide peroxide. Suitable metal chlorites include calcium chlorite, barium chlorite, magnesium chlorite, lithium chlorite, sodium chlorite, and potassium chlorite. Additional whitening actives may be hypochlorite and chlorine dioxide. In one embodiment the chlorite is sodium chlorite. In another embodiment the percarbonate is sodium percarbonate. In one embodiment the persulfates are oxones. The level of these substances is dependent on the available oxygen or chlorine, respectively, that the molecule is capable of providing to bleach the stain. Whitening agents may be present at levels from about 0.01% to about 40%, in one embodiment from about 0.1% to about 20%, in another embodiment form about 0.5% to about 10%, and in yet another embodiment from about 4% to about 7%, by weight of the composition.

Antioxidants are generally recognized as useful in oral care compositions. Antioxidants are disclosed in texts such as Cadenas and Packer, The Handbook of Antioxidants, © 1996 by Marcel Dekker, Inc. Antioxidants useful in the present invention include, but are not limited to, Vitamin E, ascorbic acid, Uric acid, carotenoids, Vitamin A, flavonoids and polyphenols, herbal antioxidants, melatonin, aminoindoles, lipoic acids and mixtures thereof.

Antiviral actives useful in the present invention include any known actives that are routinely used to treat viral infections. Such antiviral actives include, but are not limited to: phosphonoformic acid; cyosine derivatives; purine anaglogues, such as adenosine, guanosine and inosine analogues; pyrimidine bases, such as citidine and thymidine; amantadines; rimantadine HCl; ribavirin; zanamivir; oseltamivir phosphate; trifluridine; heterocyclic dyes; acyclovir; famciclovir; valacyclovir, cidofovir; ganciclovir; levimisole; idoxuridine; lipophilic β-ketones; and thiosemicarbazones. These antiviral actives are described in Drug Facts and Comparisons (loose-leaf drug information service), Wolters Kluwer Company, St. Louis, Mo., ©2001, pp. 1400-1423(b), and in Kirk-Othmer, Encyclopedia of Chemical Technology, Fourth Edition, Volume 3, Wiley-Interscience Publishers (1992), pp. 576-607.

Anti-fungal agents can also be included in the chewing gum and confection compositions of the present invention. Anti-fungals are agents that destroy or inhibit the growth of fungi. Anti-fungal agents useful in the present invention are those drugs for systemic mycoses or drugs for mucocutaneuos infections. Suitable antifungals include but are not limited to, nystatin, miconazole, econazole nitrate, clotrimazole, and flucytosine. In one embodiment the antifungal agent is nystatin.

Anti-pain or desensitizing agents can also be present in the chewing gum and confection compositions of the present invention. Analgesics are agents that relieve pain by acting centrally to elevate pain threshold without disturbing consciousness or altering other sensory modalities. Such agents may include, but are not limited to: strontium chloride; potassium nitrate; sodium fluoride; sodium nitrate; acetanilide; phenacetin; acertophan; thiorphan; spiradoline; aspirin; codeine; thebaine; levorphenol; hydromorphone; oxymorphone; phenazocine; fentanyl; buprenorphine; butaphanol; nalbuphine; pentazocine; natural herbs, such as gall nut; Asarum; Cubebin; Galanga; scutellaria; Liangmianzhen; and Baizhi. Anesthetic agents, or topical analgesics, such as acetaminophen, sodium salicylate, trolamine salicylate, lidocaine and benzocaine may also be present. These analgesic actives are described in detail in Kirk-Othmer, Encyclopedia of Chemical Technology, Fourth Edition, Volume 2, Wiley-Interscience Publishers (1992), pp. 729-737.

Histamine-2 (H-2 or H2) receptor antagonist compounds (H-2 antagonists) may be used in the chewing gum and confection compositions of the present invention. As used herein, selective H-2 antagonists are compounds that block H-2 receptors, but do not have meaningful activity in blocking histamine-i (H-1 or H1) receptors. Selective H-2 antagonists stimulate the contraction of smooth muscle from various organs, such as the gut and bronchi; this effect can be suppressed by low concentrations of mepyramine—a typical antihistaminic drug. The H-2 antagonists useful in the present invention are those that blockade the receptors involved in mepyramine-insensitive, non-H-1 (H-2), histamine responses and do not blockade the receptors involved in mepyramine-sensitive histamine responses. Selective H-2 antagonists include compounds meeting the above criteria which are disclosed in U.S. Pat. Nos. 5,294,433 and 5,364,616 both to Singer, et al., and assigned to The Procter & Gamble Company, wherein the selective H-2 antagonist is selected from the group consisting of cimetidine, etintidine, ranitidine, ICIA-5165, tiotidine, ORF-17578, lupitidine, donetidine, famotidine, roxatidine, pifatidine, lamtidine, BL-6548, BMY-25271, zaltidine, nizatidine, mifentidine, BMY-25368 (SKF-94482), BL-6341A, ICI-162846, ramixotidine, Wy-45727, SR-58042, BMY-25405, loxtidine, DA-4634, bisfentidine, sufotidine, ebrotidine, HE-30-256, D-16637, FRG-8813, FRG-8701, impromidine, L-643728, and HB-408. Related suitable H-2 antagonists include burimamide and metiamide.

The chewing gum and confection compositions of the present invention may also include one or more components that provide fragrance, and/or sensate benefit (warming or cooling agents). Suitable components include, but are not limited to: menthol; menthyl lactate; wintergreen oil; peppermint oil; spearmint oil; leaf alcohol; camphor; clove bud oil; eucalyptus oil; anethole; methyl salicylate; eucalyptol; cassia, 1-8 menthyl acetate; eugenol; oxanone; alpha-irisone;, propenyl guaethol; cinnamon; thymol; linalool; benzaldehyde; cinnamaldehyde glycerol acetal, known as CGA; and mixtures thereof, as well as coolants. The coolant can be any of a wide variety of materials. Included among such materials are carboxamides, menthol, ketals, diols, and mixtures thereof. Preferred coolants in the present compositions are the paramenthan carboxyamide agents such as N-ethyl-p-menthan-3-carboxamide, known commercially as “WS-3”, N,2,3-trimethyl-2-isopropylbutanamide, known as “WS-23,” and mixtures thereof. Additional preferred coolants are selected from the group consisting of menthol, 3-1-menthoxypropane-1,2-diol known as TK-10, manufactured by Takasago, menthone glycerol acetal known as MGA manufactured by Haarmann and Reimer, and menthyl lactate known as Frescolat® manufactured by Haarmann and Reimer. The terms “menthol” and “menthyl” as used herein include dextro- and levorotatory isomers of these compounds and racemic mixtures thereof. TK-10 is described in U.S. Pat. No. 4,459,425, Amano et al. WS-3 and other agents are described in U.S. Pat. No. 4,136,163, Watson, et al. The disclosures of both are herein incorporated by reference in their entirety. The fragrances and sensates may be present from about 0.001% to about 25% by weight of the polybutene component.

Pigments may be added to the compositions herein to more precisely indicate the locations at which the composition has actually been in contact. Additionally, these substances may be suitable for modifying the color of the teeth to satisfy the consumer. These substances comprise particles that when applied on the tooth surface modify that surface in terms of absorption and, or reflection of light. Such particles provide an appearance benefit when a film containing such particles is applied over the surfaces of a tooth or teeth. Pigments, dyes, colorants and lakes may also be added to modify the appearance of the compositions herein to render the product more acceptable to the consumer. Appropriate pigment levels are selected for the particular impact that is desirable to the consumer. For example, for teeth that are particularly dark or stained one would typically use pigments in sufficient amounts to lighten the teeth. On the other hand, where individual teeth or spots on the teeth are lighter than other teeth, pigments to darken the teeth may be useful. The levels of pigments and colorants may be in the range of about 0.001% to about 20%, in one embodiment from about 0.01% to about 15% and in another embodiment from about 0.1% to about 10% by total weight of the chewing gum or confection composition.

Pigments and colorants include inorganic white pigments, inorganic colored pigments, pearling agents, filler powders and the like; see Japanese Published Patent Application Kokai No. 9 [1997]-100215, published Apr. 15, 1997, incorporated herein by reference. Specific examples are selected from the group consisting of talc, mica, magnesium carbonate, calcium carbonate, magnesium silicate, aluminum magnesium silicate, silica, titanium dioxide, zinc oxide, red iron oxide, brown iron oxide, yellow iron oxide, black iron oxide, ferric ammonium ferrocyanide, manganese violet, ultramarine, nylon powder, polyethylene powder, methacrylate powder, polystyrene powder, silk powder, crystalline cellulose, starch, titanated mica, iron oxide titanated mica, bismuth oxychloride, and mixtures thereof. In one embodiment the pigments and colorants are those selected from the group consisting of titianium dioxide, bismuth oxychloride, zinc oxide, Opatint D&C Red 27, CI 16185:1 Acid 27 Lake E123, C114720:1Carmosoisine Aluminum Lake E122, Red 7 Lake, or Red 30 Lake and mixtures thereof.

Additional actives suitable for use in the present invention may include, but are not limited to, insulin, steroids, herbal and other plant derived remedies, and anti-neoplastics. Additionally, anti-gingivitis or gum care agents known in the art may also be included. Components, other than polybutene, which impart a clean feel to the teeth may optionally be included. These components may include, for example, baking soda or Glass-H. Also, it is recognized that in certain forms of therapy, combinations of these above-named agents may be useful in order to obtain an optimal effect. Thus, for example, an anti-microbial and an anti-inflammatory agent may be combined in a single chewing gum or confection piece to provide combined effectiveness.

Carrier Materials

In preparing compositions of the present invention, it is desirable to add one or more carrier materials. Such materials are well known in the art and are readily chosen by one skilled in the art based on the physical and aesthetic properties desired for the chewing gum or confection compositions being prepared. The carrier materials may be water insoluble materials and thus typically not released in the mouth, such as those materials used to form a chewing gum base, or water soluble materials which are released in the mouth. These carrier materials typically comprise from about 30% to about 99%, in another embodiment from about 40% to about 98%, in yet another embodiment from about 70% to about 95%, by weight of the composition.

I. Chewing Gum Carrier Materials

The following is a non-limiting list of carrier materials suitable for incorporating into a chewing gum.

Where the compositions of the present invention are in chewing gum form, a chewable gum base is included. Illustrative examples of suitable polymers for use as a gum base include both natural and synthetic water-insoluble elastomers and rubbers. Examples of suitable gum base polymers include, without limitation, substances of vegetable origin such as chicle, jelutong, balata, gutta-percha, lechi capsi, sorva, guayule rubber, crown gum, natural rubber, nispero, rosidinha, perillo, niger gutta, tunu, gutta kay and the like, and mixtures thereof. Examples of synthetic elastomers include, without limitation, styrene-butadiene copolymers, polyvinylacetate, polyethylene, high molecular weight polyisobutylene, and mixtures thereof. The amount of gum base polymer employed in the chewing gum outer shell composition will vary considerably depending on various factors such as the type of gum base used, the consistency of the chewing gum outer shell composition desired and the other components used in the composition to make the final chewing gum product. Generally the gum base polymer is present in the chewing gum component from about 5% to about 50% by weight based on the total weight of the chewing gum component.

The chewing gum component for use in present invention may comprise a plasticiser in an amount up to about 10%, in one embodiment from about 0.1% to about 3% by weight of the chewing gum component. Suitable plasticisers include glyceryl triacetate, acetylated monoglyceride, glyceryl tributyrate, ethyl laurate, ethyl acetoacetate, diethyl tartrate, ethyl or butyl lactates, diethyl malate, ethyl oleate, castor oil, succinylated monoglycerides or mixtures thereof. Glyceryl triacetate and acetylated monoglyceride are preferred. A further optional but desirable ingredient of the chewing gum component is a resin. The resin also serves to plasticise the gum base. Suitable resins for use herein include polyvinyl acetate (PVA) and terpene resins, including polyterpene and polymers of alpha-pinene or beta-pinene, and mixtures thereof. The resin can conveniently be used at a level of from about 3% to about 25%, in one embodiment from about 5% to about 20% by weight of the chewing gum component.

A further desirable ingredient of the chewing gum component is an elastomer solvent. The elastomer solvent aids in softening the chewing gum component. Such elastomer solvents include methyl, glycerol or pentaerythritol esters of rosins or modified rosins, such as hydrogenated, dimerized or polymerised rosins or mixtures thereof. Examples of elastomer solvents suitable for use herein include the pentaerythritol ester of partially hydrogenated wood rosin, pentaerythritol ester of wood rosin, glycerol ester of partially dimerized rosin, glycerol ester of polymerised rosin, glycerol ester of tall oil, wood or gum rosin, glycerol ester of partially hydrogenated rosin, methyl ester of partially hydrogenated rosin, and mixtures thereof. The elastomer solvent can be employed in an amount ranging from about 2% to about 50%, in one embodiment from about 10% to about 35% by weight of the chewing gum component.

The chewing gum component can also include one or more waxes. Suitable waxes include paraffin wax; microcrystalline wax; Fischer-Tropsch paraffin; natural waxes such as candellilla, carnauba and beeswax; polyolefin waxes such as polyethylene wax; and mixtures thereof. The waxes may be present up to about 25%, in one embodiment from about 5% to about 20% by weight of the gum composition.

II. Chewing Gum or Confection Carrier Materials

The following carrier materials are suitable for incorporation into either a chewing gum or confection composition.

An abrasive polishing material may be included in the chewing gum or confection compositions. The abrasive polishing material contemplated for use in the compositions of the present invention can be any material that does not excessively abrade dentin. The abrasive polishing material should be formulated in the chewing gum composition so that it does not compromise the stability of any ingredients. Typical abrasive polishing materials include silica gels and precipitates; aluminas; water insoluble phosphates (including orthophosphates, polymetaphosphates, and pyrophosphates); and mixtures thereof. Specific examples include dicalcium orthophosphate dihydrate, calcium pyrophosphate, tricalcium phosphate, calcium polymetaphosphate, insoluble sodium polymetaphosphate, hydrated alumina, beta calcium pyrophosphate, calcium carbonate, and resinous abrasive materials such as particulate condensation products of urea and formaldehyde and melamine urea formaldehyde. Mixtures of abrasives may also be used. The abrasive in the chewing gum compositions is generally from about 1% to about 70%, in one embodiment from about 5% to about 50%, by weight of the chewing gum or confection component.

Various fats can also be included in the compositions of the present invention. Preferred fats include the hydrogenated vegetable oils such as hydrogenated palm oil, hydrogenated soybean oil, hydrogenated cottonseed oil and various other hydrogenated vegetable oils and mixtures thereof. The fats can suitably be used at a level up to about 20%, in one embodiment from about 1% to about 10%, by weight of the chewing gum or confection component.

The compositions also may include an emulsifier. Suitable emulsifiers include glycerol monostearate, lecithin, fatty acid monoglycerides, diglycerides, propylene glycol monostearate and mixtures thereof. The emulsifier is employed in amounts up to about 10%, in one embodiment from about 2% to about 6%, by weight of the chewing gum or confection component.

A variety of softeners can also be employed in the compositions of the present invention. Suitable softeners inchide, without limitation, fatty materials such as lanolin, stearic acid, sodium stearate and potassium stearate; polyhydric alcohols such as glycerine and propylene glycol; and mixtures thereof. The softeners can suitably be used at a total level of up to about 30%, in one embodiment from about 0.5% to about 25%, in another embodiment from about 0.1% to about 10%, by weight of the composition. Such materials, when incorporated, assist in modifying the texture and consistency properties of the chewing gum or confection. In particular, they are useful in softening the chew and in maintaining chew softness over an extended period of time in gums and soft candies.

Bulking agents, such as fillers, can also be employed in the present chewing gum or confection compositions. Suitable fillers and bulking agents are generally non-abrasive; in one embodiment with an average particle size less than 5 μm, in another embodiment less than 3 μm and in yet another embodiment less than 1 μm. Illustrative bulking agents include calcium carbonate or ground limestone, talc, aluminium hydroxide, alumina, aluminium silicates, dicalcium phosphate and mixtures thereof. Where present, the filler can be used in levels up to about 50%, in one embodiment up to about 30%, in another embodiment from up to about 10% by weight of the chewing gum or confection component.

Suitable bulk sweeteners for use in the chewing gums and confections of the present invention include monosaccharides, disaccharides, and polysaccharides such as xylose, ribose, glucose, mannose, galactose, fructose, dextrose, sucrose, sugar maltose, fructo oligo saccharide syrups, partially hydrolysed starch, or corn syrup solids. Preferred sweetening agents are sugar alcohols such as sorbitol, xylitol, mannitol, maltitol, isomalt, hydrogenated starch hydrolisate, inulin, and other non-carigenic edible polyols such as glycerin and erythritol, and mixtures thereof. The compositions may comprise a high intensity, low calorie sweetener, either alone or in combination with a bulk sweetener. Suitable high intensity sweeteners include: dipeptide based sweeteners such as L-aspartyl-L-phenylalanine methyl ester (Aspartame) and equivalents described in U.S. Pat. No. 3,492,131, L-α-aspartyl-N-(2,2,4,4-tetramethyl-3-thietanyl)-D-alaninamide hydrate (Alitame) and the like; the soluble saccharin salts, i.e., sodium or calcium saccharin salts; cyclamate salts, acesulfame-K and the like; the free acid form of saccharin; chlorinated derivatives of sucrose such as chlorodeoxysucrose and the like; and protein based sweeteners, such as Thaumatin (talin). In general, the amount of sweetener will vary with the sweetener selected for use and level of sweetness desired for a particular chewing gum or confection. This amount will normally vary from about 0.01% when using a high intensity sweetener to about 80%, by weight of the total composition when using an easily extractable bulk sweetener. The bulk sweeteners described above, are used in amounts from about 10% to about 80%, in one embodiment from about 30% to about 70%, by weight of the total chewing gum or confection composition. The high intensity sweeteners described can be added in amounts of from about 0.01% to about 2.0% and in one embodiment from about 0.05% to about 0.5% by total weight of the compositions. These amounts are ordinarily necessary to achieve a desired level of sweetness independent from the flavor level achieved from the flavoring agents. The sweetener can be added to the chewing gum or confection component, may be added to the polybutene component or both.

Flavorants, or flavoring agents, well known in the chewing gum and confection art can be added to the compositions of the present invention. The flavorant can be added to the chewing gum or confection component, may be added to the polybutene component or both. These flavoring agents can be chosen from synthetic flavoring liquid and/or oils derived from plants leaves, flowers, fruits and so forth, and combinations thereof. Representative flavoring liquids include: spearmint oil, cinnamon oil, oil of wintergreen (methylsalicylate) and peppermint oils. Also useful are artificial, natural or synthetic fruit flavors such as citrus oil including lemon, orange, banana, grape, lime, apricot and grapefruit and fruit essences including apple, strawberry, cherry, orange, pineapple and so forth; bean and nut derived flavors such as coffee, cocoa, cola, peanut, almond and so forth. Additionally, flavor adsorbed onto a hydrophilic matrix may be included, e.g. “spray-dried” flavors. Furthermore, encapsulated flavors may be included. The amount of flavorant employed is normally a matter of preference subject to such factors as flavor type, chewing gum base type and strength of flavor desired. A flavaorant may be present in amounts up to about 4%, in one embodiment about 0.05% to about 3.0%, in another embodiment about 0.8% to about 2.5%, by weight of the composition.

Water may be employed in the preparation of commercially suitable chewing gum and confection compositions and should be of low iron content and free of organic impurities. Water will generally comprise less than about 50%, in one embodiment from about 0.01% to about 25%, and in another embodiment from about 0.1% to about 10%, by weight of the composition herein. The amounts of water include the free water which is added plus that which is introduced with other materials, such as with sorbitol, silica, and solutions.

The chewing gum and confection compositions may further comprise a viscosity modifier that inhibits settling and separation of components or controls settling in a manner that facilitates re-dispersion and may control flow properties. Viscosity modifiers may be particularly useful where the compositions conatin a void filled with the polybutene component, which contains an active ingredient in particulate form suspended therein. Suitable viscosity modifiers herein include mineral oil, organo modified clays, petrolatum, silicas, and mixtures thereof In one embodiment the viscosity modifier is silica. Where incorporated, the viscosity modifier is present at a level of from about 0.001% to about 75%, in one embodiment from about 0.01% to about 50%, and in another embodiment from about 0. 1% to about 25%, by weight of the polybutene component.

Compositions of the present invention may contain some thickening material or binders to provide a desirable consistency. Preferred thickening agents are carboxyvinyl polymers, carrageenan, hydroxyethyl cellulose, and water-soluble salts of cellulose ethers such as sodium carboxymethylcellulose and sodium hydroxyethyl cellulose. Natural gums such as gum karaya, xanthan gum, gum arabic, and gum tragacanth can also be used. Colloidal magnesium aluminum silicate or finely divided silica can be used as part of the thickening agent to further improve texture. Thickening agents can be used in an amount from about 0.1% to about 15%, by weight of the confection or chewing gum component.

Another optional component of the compositions described herein is a humectant. The humectant serves to keep compositions from hardening upon exposure to air and certain humectants can also impart desirable sweetness of flavor. Suitable humectants for use in the invention include glycerin, sorbitol, polyethylene glycol, and other edible polyhydric alcohols. The humectant may comprise from about 0% to about 70%, and in one embodiment from about 15% to about 55%, by weight of the chewing gum or confection component.

The composition of the present invention may include xylitol. Xylitol is a sugar alcohol used as a sweetener or humectant. Xylitol may also provide a therapeutic effect, such as an antibacterial or anti-caries effect. The present compositions may comprise xylitol at a level from about 0.01% to to about 25%, in one embodiment from about 3% to about 15%, in another embodiment from about 5% to about 12%, and in yet another embodiment from about 9% to about 11%, by weight of the chewing gum or confection component. Alternatively, if xylitol is used as a sweetener, it may be present at a lower level, such as from about 0.005% to about 5%, by weight of the composition.

The present invention may include an alkali metal bicarbonate salt as a carrier material. Alkali metal bicarbonate salts are soluble in water and unless stabilized, tend to release carbon dioxide in an aqueous system. Sodium bicarbonate, also known as baking soda, is the preferred alkali metal bicarbonate salt. The alkali metal bicarbonate salt also functions as a buffering agent. The present composition may contain from about 0.5% to about 50%, in one embodiment from about 0.5% to about 30%, in another embodiment from about 2% to about 20%, and in yet another embodiment from about 5% to about 18% of an alkali metal bicarbonate salt, by weight of the chewing gum or confection component.

The compositions may contain a buffering agent. “Buffering agents”, refer to agents that can be used to adjust the pH of the compositions to a range of about pH 3 to about pH 10. The buffering agents include alkali metal hydroxides, carbonates, sesquicarbonates, borates, silicates, phosphates, imidazole, and mixtures thereof. Specific buffering agents include monosodium phosphate, trisodium phosphate, sodium hydroxide, potassium hydroxide, alkali metal carbonate salts, sodium carbonate, imidazole, pyrophosphate salts, citric acid, and sodium citrate. Buffering agents may be used at a level of from about 0.1% to about 30%, in one embodiment from about 1% to about 10%, and in another embodiment from about 1.5% to about 3%, by weight of the total compositions.

Method of Preparation

The method of manufacturing the present compositions forms no part of this invention. Means for preparing chewing gums and confections are well known in the art. The following disclosure is simply for the convenience of the formulator and is not intended to limit the methods which can be employed herein. The overall compositions of the present invention are comprised of a polybutene component and a chewing gum or confection component. One or more of the polybutene, gum or confection components may optionally comprise a cosmetic or therapeutic active, and flavorants and/or sweeteners and other ingredients, as described above. The polybutene component may be discretely and evenly dispersed throughout the chewing gum or confection component. Preferably the polybutene component will be homogenously mixed throughout the confection or chewing gum component. Alternatively, the polybutene component may be used as fill where the chewing gum or confection component forms an outer shell, encapsulating a void.

The chewing gum compositions of the present invention may be in any conventional chewing gum form such as stick, chunk, shredded, square, cube, ball, pillow, tablet, or slab, either coated or uncoated. The chewing gum may also be a digestible or dissolvable gum suitable for chewing. A chewing gum is typically retained in the oral cavity for a sufficient time to allow ingredients released to contact substantially all of the dental surfaces and/or oral tissues.

Where a confection composition is preferred, the confection component may be in any conventional form such as hard candy, powdered candy, boiled candy, chocolates, carmels, jellies, gummy candy, nougat or toffee, either hard or soft. The confection may be sugared or sugarless.

Where the polybutene component comprises lower molecular weight polybutene and one or more cosmetic and/or therapeutic actives the following method of preparation is employed. The lower molecular weight polybutene is combined with one or more cosmetic and/or therapeutic active ingredients in a mixing vessel and mixed well with any means known in the art, for example, with spatula or mechanical mixer. Heat may be added to the composition during mixing. Mixing continues until the polybutene component is substantially homogenous. Where the cosmetic and/or therapeutic active ingredient is in solid particulate form, the addition of a viscosity modifier, such as silica, may be appropriate to keep the particulate dispersed and suspended within the composition.

The compositions herein may be in the form of a pellet or other form that contains an outer coating or shell around the central portion or core of the chewing gum or confection. Typically the outer coating will be comprised of sorbitol, malitol, xylitol, isomalt and other crystalizable polyols. The outer coating may also contain small amounts of water or gum arabic. A polyol coating can be further coated with wax. Where a cosmetic or therapeutic active is desirable the active may be added to the coating for immediate release. Where actives are included that are incompatible, it may be desirable to add one or more actives to the polyol coating.

Method of Use

The compositions are typically retained in the oral cavity for a sufficient time to allow ingredients released to contact substantially all of the hard dental surfaces and/or oral tissues. The chewing gum composition is masticated by the consumer to deliver the polybutene coating to the surface of the teeth and, optionally, to deliver a cosmetic and/or therapeutic active to the oral cavity. The confection may be chewed or dissolved in the mouth of the consumer to achieve the same benefits. The above compositions are masticated for one minute to three hours to release the polybutene and any optional cosmetic and/or therapeutic actives or ingredients. Where a cosmetic and/or therapeutic active ingredient is to be delivered with the subject composition, a coating containing the cosmetic and/or therapeutic active ingredient quickly forms on the hard surface to which the composition has been applied. Prolonged delivery of the cosmetic and/or therapeutic active ingredient., where incorporated, is made possible as the cosmetic and/or therapeutic active ingredient is released over time from the aforementioned coating.

It is not necessary to prepare the oral cavity before using the composition of the present invention. For example, the user may or may not choose to brush the teeth or rinse the mouth before applying the composition. The hard surfaces of the oral cavity are neither required to be dried nor to be excessively wet with saliva or water before the composition is applied. However, it is believed that adhesion to the teeth or hard surfaces will be improved if the teeth or hard surfaces are somewhat dry when the composition is applied.

It should be understood that the present invention relates not only to the use of low molecular weight polybutene in a chewing gum or confection for use or consumption by a human, but may also be incorporated in food items prepared for use or consumption by an animal, e.g. household pets or other domestic animals, or animals kept in captivity.

### EXAMPLES

The following non-limiting examples further illustrate and describe the embodiments of the subject invention wherein both essential and optional ingredients are combined. It is to be understood that the examples are given solely for the purpose of illustration and are not to be construed as limiting the scope of the present invention, as many variations thereof are possible without departing from the spirit and scope of the invention.

Polybutene Component

Polybutene is combined with one or more cosmetic and/or therapeutic active ingredients, upon weighing, into a mixing vessel and mixed well with any means known within the art, for example, with spatula or mixer. Values given below are in weight percent of total fill composition.

Examples 1-6

| Ingredients | Ex. 1 | Ex. 2 | Ex. 3 | Ex. 4 | Ex. 5 | Ex. 6 |
|---|---|---|---|---|---|---|
| Polybutene¹ | 87% | 99.7% | 99.742% | 99.56% | 99.84% | 75.00% |
| Glass-H | | 13% | | | | 25.00% |
| Triclosan | | 0.3% | | | | |
| Thymol | | | 0.064% | | | |
| Eucalyptol | | | 0.092% | | | |
| Menthol | | | 0.060% | 0.12% | | |
| Methyl Salicylate | | | 0.042% | | | |
| Menthyl Lactate | | | | 0.17% | | |
| Peppermint | | | | 0.15% | | |
| 8-hydroxyquinoline salts | | | | | 0.10% | |
| CuCl₂·2H₂0 | | | | | 0.06% | |

Examples 7-12

| Ingredients | Ex. 7 | Ex. 8 | Ex. 9 | Ex. 10 | Ex. 11 | Ex. 12 |
|---|---|---|---|---|---|---|
| Polybutene² | 90% | 80% | 99.955% | 99.757% | 99.97% | 99.1% |
| CPC | | | 0.045% | | | 0.09% |
| Apple Extract | 10% | | | | | |
| Baking Soda | | 20% | | | | |
| Sodium Fluoride | | | | 0.243% | | |
| Nystatin | | | | | 0.03% | |

Examples 13-19

| Ingredients | Ex. 13 | Ex. 14 | Ex. 15 | Ex. 16 | Ex. 17 | Ex. 18 | Ex. 19 |
|---|---|---|---|---|---|---|---|
| Polybutene³ | 90% | 90% | 90% | 99.76% | 99.76% | 99.76% | 99.066% |
| Carvacrol | 10% | | | | | | |
| Grape Seed Extract | | 10% | | | | | |
| Opatint D&C Red 27 | | | | 0.24% | | | |
| Red 7 | | | | | 0.24% | | |
| Red 30 | | | | | | 0.24% | |
| Grapefruit Seed Extract | | | 10% | | | | |
| Calcium Peroxide | | | | | | | 0.934% |

Examples 20-25

| Ingredients | Ex. 20 | Ex. 21 | Ex. 22 | Ex. 23 | Ex. 24 | Ex. 25 |
|---|---|---|---|---|---|---|
| Polybutene⁴ | 90% | 99% | 99.47% | 97.95% | 99.24% | 92.5% |
| Xylitol | 10% | | | | | |
| Chlorexidine | | 1% | | | | |
| Stannous Fluoride | | | 0.53% | | | |
| Tetra Sodium Pyrophosphate | | | | 2.05% | | |
| Eugenol | | | | | | 7.5% |
| Mono Fluoro Phosphate | | | | | 0.76% | |

Examples 26-33

| Ingredients | Ex. 26 | Ex. 27 | Ex. 28 | Ex. 29 | Ex. 30 | Ex. 31 | Ex. 32 | Ex. 33 |
|---|---|---|---|---|---|---|---|---|
| Polybutene⁵ | 81% | 81% | 81% | 80% | 56% | 80% | 81% | 100% |
| Sodium Percarbonate | 19% | | | 19% | 19% | | | |
| Urea Peroxide | | 19% | | | | | | |
| Calcium Peroxide | | | 19% | | | | | |
| Silica | | | | 1% | | | | |
| Petrolatum | | | | | 25% | | | |
| Benzocaine | | | | | | 20% | | |
| (Polyvinyl-Pyrrolidone) | | | | | | | 19% | |
| Peroxide Complex | | | | | | | | |

Examples 34-37

| Ingredients | Ex. 34 | Ex. 35 | Ex. 36 | Ex. 37 |
|---|---|---|---|---|
| Polybutene⁶ | 63.76% | 54.5% | 60.5% | 61.5% |
| Petrolatum | 10.00% | 12.5% | 12.5% | 12.5% |
| Silica | 1.00% | 1.0% | 1.0% | 1.0% |
| Glass-H | 25.00% | 25.0% | 25.0% | 25.0% |
| Peppermint Oil | | 6.0% | | |
| Asparatame | | 1.0% | 1.0% | |
| Opatint 27 | 0.24% | | | |

¹Indopol H-300, MW = 1330, trade name of BP Amoco Chemicals (Chicago, IL).
²Indopol H-40, MW = 750, trade name of BP Amoco Chemicals (Chicago, IL).
³Indopol H-100, MW = 940, trade name of BP Amoco Chemicals (Chicago, IL).
⁴Indopol H-1900, MW = 2270, trade name of BP Amoco Chemicals (Chicago, IL).
⁵Indopol H-300, MW = 1330, trade name of BP Amoco Chemicals (Chicago, IL).
⁶Indopol H-300, MW = 1330, trade name of BP Amoco Chemicals (Chicago, IL).

It should be understood that the above-described polybutene-containing components may be combined in any ratio and used in the chewing gum and confection compositions herein. It should also be understood that these examples are non-limiting. The level of polybutene and cosmetic and therapeutic actives exemplified herein may vary by as much as 80% and still be suitable for use in the compositions disclosed herein.

The polybutene component is then dispersed within the chewing gum or confection compositions while the compositions are still capable of being manipulated by mechanical mixing. Mixing is continued until the compositions are substantially homogenous.

Alternatively, if a filled composition is preferred, the polybutene component may be enrobed within the chewing gum or confection outer shell composition by dipping, rolling or any other coating means known in the art. The chewing gum or confection outer shell may be created by extrusion, or other conventional means, creating a center void into which the fill composition is injected or poured.

The Chewing Gum or Confection Component

The chewing gum component can be manufactured in any conventional manner, such as those described in U.S. Pat. No. 4,352,823, incorporated herein by reference. In general, the chewing gum is prepared by heating and blending various ingredients which may include, natural gums, sweeteners, flavorants, colorants, softeners, or a therapeutic and/or cosmetic active, in a manner well known in the art. It will be appreciated that substantially any conventional type chewing gum may be employed in forming the chewing gum component of the present invention. The polybutene component is then combined with the chewing gum component by any means, such as a mechanical mixer, until the two components are evenly mixed. Preferably, the final composition is a homogenous mixture where the polybutene component is evenly distributed throughout the chewing gum component.

Values given below are in weight percent of total chewing gum component unless otherwise indicated. Example A shows a typical chewing gum. Example B shows a chewing gum where one active ingredient is included therein.

Chewing Gum Examples A-B

| Ingredients | Ex. A | Ex. B |
|---|---|---|
| Sorbitol | 33.35% | 18.35% |
| Xylitol | 16.70% | 16.70% |
| Gum Base | 28.00% | 28.00% |
| Sodium Polyphosphate (Glass-H) | | 15.00% |
| Hydrogenated starch hydrolysate | 8.00% | 8.00% |
| Glycerin | 7.00% | 7.00% |
| Mannitol | 5.00% | 5.00% |
| Flavor | 1.60% | 1.60% |
| Aspartame | 0.20% | 0.20% |
| Spray Dried Flavor | 0.15% | 0.15% |

Values given below are in weight percent of total confection composition.

Confection Composition Examples C-E

| | Ex. C | Ex. D | Ex. E |
|---|---|---|---|
| Ingredients | Hard | Soft—Jelly | Hard Sugarless |
| Mannitol | 2.0% | | 2.08% |
| Sucrose | 48.0% | | |
| Corn Syrup | 50.0% | 21.83% | |
| Crystalline Dextrose | | 7.35% | |
| Granulated Sugar | | 20.43% | |
| Potato Starch | | 2.35% | |
| Corn Starch | | 4.09% | |
| Water | | 43.95% | |
| Hydrogenated Starch | | | 95.77% |
| Hydrolysate | | | |
| Sorbitol | | | 2.08% |
| Cherry Flavor | | | 0.07% |

Chewing gum compositions as described above are prepared as follows: Heat gum base to ˜45° C. to soften. Maintain mixer vessel cavity at 45° C. during entire mixing process. Add gum base to mixing cavity of double sigma blade mixer and mix for 5 minutes. Add mannitol and spray-dried flavor. Mix for 2 minutes. Add glycerin and mix for 2 minutes. Add 50% of xylitol and mix for 2 minutes. Add hydrogenated starch hydrolysate and mix for 5 minutes. Add 50% sorbitol and mix for 3 minutes. Add second 50% of xylitol, second 50% of sorbitol and aspartame and mix for 3 minutes. Add flavorant and mix for 3 minutes. This chewing gum component is then filled with or used to enrobe any of the polybutene components described in examples 1-29. Where a therapeutic or cosmetic active is added to the chewing gum component, it is added with the aspratame. Where it is desired that the polybutene component be dispersed throughout the chewing gum component, the any of the polybutene components described in examples 1-29 are added when the flavorant is added, and mixed as described, until uniform.

A soft confection component is prepared using conventional methods as described in U.S. Pat. No. 4,466,983, incorporated herein by reference. Generally, such compositions are prepared by combining high boiling syrup, such as corn syrup to a light textured frappe made of gelatin, egg albumen, milk proteins and vegetable proteins. These ingredients are combined under agitation, at a temperature of at least 65° C.; in one embodiment about 100° C. The ingredients are mixed until uniform and cooled to a temperature below 80° C. where the additional ingredients, such as flavorants, colorants, therapeutic and/or cosmetic actives and preservatives, are added. The soft confection component is mixed again to achieve uniformity and then ready for removal and shaping. During this final mixing stage, the polybutene component, which may be any of those disclosed in examples 1-29, may be added to the soft confection component and mixing continued until evenly distributed. Preferably, the final composition is a homogenous mixture where the polybutene component is evenly distributed throughout the confection component.

Where a hard confection component is desired it is also made by conventional methods using fire cookers, vacuum cookers and high-speed atmospheric cookers. In one embodiment, hard confections are made by boiling the desired amount of sugar, typically beet or cane sugar, and glucose syrup, such as corn syrup, in a vacuum cooker at about 125° to about 132° C. Vacuum is applied and additional water is boiled off without extra heating. When cooking is complete the mass is a semi-solid, having a plastic like consistency. The polybutene component, which may be any of those described in examples 1-29, as well as any desired flavorants, colorants, preservatives or other additional ingredients, is then mixed in the mass, prior to cooling by routine mechanical means. These ingredients are preferably homogenously mixed throughout the hard confection component.

In one embodiment the overall composition is a filled chewing gum or confection comprising an outer shell encapsulating a void wherein the polybutene component, comprising polybutene with a molecular weight from about 300 to about 3000 and optionally a cosmetic or therapeutic active, flavorant, and/or sweetener, is contained. Once the chewing gum or confection component is prepared, an outer shell may be formed with the use of a mold so that an internal void exists which is suitable for filling, for example, by injection with the fill composition. Alternatively, the polybutene component may be enrobed within the outer shell by dipping, rolling or other coating processes known in the art. In one embodiment the chewing gum or confection outer shell may be filled with the polybutene component using conventional methods as described in U.S. Pat. No. 4,683,138 and U.S. Pat. No. 4,975,288. Chewing gum or soft confection components are fed into an extruder and extruded through an orifice to a hollow center rope of material. The polybutene component is fed, under pressure, through an inner conduit to the hollow center of the outer shell material. The rope is fed into a sizing unit where rollers decrease the cross-sectional dimension of the rope and form individual gum or confection units.

It is understood that the examples and embodiments described herein are for illustrative purposes only and that various modifications or changes in light thereof will be suggested to one of skill in the art without departing from the scope of the present invention.

What is claimed is:

1. A chewing gum composition comprising:
(a) a polybutene component comprising polybutene with a molecular weight of about 300 to about 3000; and
(b) a chewing gum component comprising at least one carrier material.

2. The chewing gum composition according to claim 1 wherein the polybutene has a molecular weight of about 500 to about 2200.

3. The chewing gum composition according to claim 2 wherein the polybutene has a molecular weight of about 750 to about 1500.

4. The chewing gum composition according to claim 1 wherein the composition further comprises at least one cosmetic or therapeutic active.

5. The chewing gum composition according to claim 4 wherein the cosmetic or therapeutic active is selected from the group consisting of anti-calculus agents; fluoride ion sources; stannous ion sources; whitening agents; anti-microbial; anti-plaque agents; anti-inflammatory agents; nutrients; antioxidants; anti-viral agents; anti-fungal agents; analgesic and anesthetic agents; H-2 antagonists; components other than polybutene which impart a clean feel to the teeth; fragrances and sensates; pigments, dyes, lakes and colorants; flavorants; sweeteners; and mixtures thereof.

6. The chewing gum composition according to claim 5 wherein the cosmetic or therapeutic active is selected from the group consisting of triclosan, baking soda, sodium fluoride, sodium nitrate, potassium nitrate, nystatin, grapefruit seed extract, stannous fluoride, tetra sodium pyrophosphate, mono fluoro phosphate, Opatint D&C Red 27, polyphosphates, cetylpyridinium chloride and non steroidal anti-inflammatory agents.

7. The chewing gum composition according to claim 6, wherein the polyphosphate is sodium hexametaphosphate.

8. The chewing gum composition according to claim 4, where in the composition further comprises a viscosity modifier.

9. The chewing gum composition according to claim 1 wherein the carrier material is selected from the group consisting of gum bases, resins and plasticisers, elastomer solvents, waxes, abrasive polishing materials, fats, emulsifiers, softeners, bulking agents, sweeteners, flavorants, water, thickeners, humectants, opacifiers, xylitol, alkali metal bicarbonate salts and buffering agents.

10. The chewing gum composition according to claim 1, wherein:
(a) the chewing gum component is an outer shell; and
(b) the polybutene component is a fill composition, encapsulated within said outer shell.

11. A confection composition comprising:
(a) a polybutene component comprising polybutene with a molecular weight of about 300 to about 3000; and
(b) a confection component comprising at least one carrier material.

12. The confection composition according to claim 11 wherein the polybutene has a molecular weight of about 500 to about 2200.

13. The confection composition according to claim 12 wherein the polybutene has a molecular weight of about 750 to about 1500.

14. The confection composition according to claim 11 wherein the composition further comprises at least one cosmetic or therapeutic active.

15. The confection composition according to claim 14 wherein the cosmetic or therapeutic active is selected from the group consisting of anti-calculus agents; fluoride ion sources; stannous ion sources; whitening agents; anti-microbial; anti- plaque agents; anti-inflammatory agents; nutrients; antioxidants; anti-viral agents; anti-fungal agents; analgesic and anesthetic agents; H-2 antagonists; components other than polybutene which impart a clean feel to the teeth; fragrances and sensates; pigments, dyes, lakes and colorants; flavorants; sweeteners; and mixtures thereof.

16. The confection composition according to claim 15 wherein the cosmetic or therapeutic active is selected from the group consisting of triclosan, baking soda, sodium fluoride, sodium nitrate, potassium nitrate, nystatin, grapefruit seed extract, stannous fluoride, tetra sodium pyrophosphate, mono fluoro phosphate, Opatint D&C Red 27, polyphosphates, cetylpyridinium chloride and non-steroidal anti-inflammatory agents.

17. The confection composition according to claim 16, wherein the polyphosphate is sodium hexametaphosphate.

18. The confection composition according to claim 14, wherein the composition further comprises a viscosity modifier.

19. The confection composition according to claim 11 wherein the carrier material is selected from the group consisting of abrasive polishing materials, fats, emulsifiers, softeners, bulking agents, sweeteners, flavorants, water, thickeners, humectants, opacifiers, xylitol, alkali metal bicarbonate salts and buffering agents.

20. The confection composition according to claim 11, wherein:
(a) the confection component is an outer shell; and
(b) the polybutene component is a fill composition, encapsulated within said outer shell.

21. A method of coating the teeth and hard surfaces of the oral cavity by chewing a chewing gum composition comprising polybutene, wherein the polybutene has a molecular weight of about 300 to about 3000.

22. A method of providing sustained release of therapeutic and cosmetic actives to the oral cavity by chewing a chewing gum composition comprising polybutene, wherein the polybutene has a molecular weight of about 300 to about 3000, and therapeutic and cosmetic actives.

23. A method of inhibiting and preventing gingivitis, caries, staining, fungi, bacteria and plaque build up in the oral cavity by chewing a chewing gum composition comprising polybutene, wherein the polybutene has a molecular weight of about 300 to about 3000.

24. A method of coating the teeth and hard surfaces of the oral cavity by consuming a confection composition comprising polybutene, wherein the polybutene has a molecular weight of about 300 to about 3000.

25. A method of providing sustained release of therapeutic and cosmetic actives to the oral cavity by consuming a confection composition comprising polybutene, wherein the polybutene has a molecular weight of about 300 to about 3000, and therapeutic and cosmetic actives.

26. A method of inhibiting and preventing gingivitis, caries, staining, fungi, bacteria and plaque build up in the oral cavity by consuming a confection composition comprising polybutene, wherein the polybutene has a molecular weight of about 300 to about 3000.
